(19) United States
(12) Patent Application Publication
(10) Pub. No.: US 2005/0166633 A1
(43) Pub. Date: Aug. 4, 2005

(54) Method for separation or molecular/atomic/ionic mixtures

(76) Inventors: Yashonath Subramanian, BANGALORE (IN); Ananthakrishna Garani, Bangalore (IN); Anil Kumar Anil Nivas Vasudevan Nair, Bangalore (IN)

Correspondence Address: DLA PIPER RUDNICK GRAY CARY US, LLP, 2000 UNIVERSITY AVENUE, E. PALO ALTO, CA, 94303-2248, US

(21) Appl. No.: 10/499,185

(22) PCT Filed: Dec. 18, 2002
(86) PCT No.: PCT/IN02/00237

(30) Foreign Application Priority Data
Dec. 18, 2001 (IN) 1006/MAS/2001

(51) Int. Cl. B03C 3/14

(52) U.S. Cl. 62/617; 95/63; 95/66

(57) ABSTRACT

Disclosed herein is an improved method for separation of molecular/atomic/ionic mixtures. An efficient process for separation of multicomponent mixtures (including binary mixtures) is the object of the invention. both the levitation effect and blow torch effect are used simultaneously for paration of mixtures for the first time.

This invention relates to an improved method of separation of molecular/atomic/ionic mixtures using a judicious combination of both “Levitation” and “Blow Torch” effects.

The separation process can be used as an isolated process or in combination with another process, such as, for example catalysis.

### BACKGROUND INFORMATION AND CLASSIFICATION OF METHODS

Mixtures of atoms or molecules which exist in nature often need to be separated for industrial and other purposes. In Biology, protein isolation is important and necessary to the study of its properties. Separation of mixtures of molecules or atoms or ions can be achieved by a number of processes. Distillation, chromatography, adsorption, membrane-based separation and crystallization are some of the conventional methods employed for separation [References 1-20]. All these methods can be classified under two types as follows:
(i) Equilibrium based methods; and
(ii) Kinetic based methods.
   For example, in one of the standard equilibrium based methods when a particular pressure is given to the components of mixtures, one of the component of the mixture adsorbs/absorbs while the other does not for the same pressure thus the components get separated.

Kinetic based methods utilize the fact that transport properties (usually self diffusivity or transport diffusivity) of the two components are different.

Separation is of great commercial importance. For example, crude oil needs to be separated into different streams each containing hydrocarbons of different sizes, Cₙ(1<n<20). Without such a separation, one cannot obtain air fuel, petrol, kerosene, diesel, tar etc. There are many other well-known industrial requirements for the separation of mixtures: N₂/O₂, linear and branched alkanes, benzene and its derivatives, saturated and unsaturated hydrocarbons (propane/propylene mixtures, ethane/ethylene mixture). The economic or financial cost can be very large, when the separation methods with lower efficiency are used, since these methods are used on millions of tons of mixtures every year.

In the known methods of separation, (References 1-12), there exist several drawbacks. For example, distillation is highly energy intensive, relatively unsafe and expensive. In known membrane-based separations, diffusion is sometimes slow and a high degree of separation is not often obtained. The efficiency of separation achieved by any method may be quantified by the “separation factor” (also known as “separation power”) defined as:

$$\begin{matrix}α = \frac{( mole ratio of A \text{/} B in extract )}{( mole ratio of A \text{/} B in raffinate )} \\ = \frac{\frac{{c}_{1}^{a}}{{c}_{1}^{b}}}{\frac{{c}_{2}^{a}}{{c}_{2}^{b}}}\end{matrix} \qquad ( 1 )$$

where c is the measure of the composition such as mole fraction, concentration in moles or mass per unit volume. a and b are the two components of the mixture to be separated and 1 and 2 are the two product streams after the separation. Extract is enriched with one of the two components while raffinate is enriched with the other components. The separation factor obtained depends on the method and varies over a wide range for different processes. Many of these methods, (References 1-20), are “passive”, in the sense that the separation occurs because of the difference in the transport properties in the case of kinetic-based separation methods. These are frequently slow due to low transport coefficient of the components and therefore expensive. In an adsorption-desorption equilibrium-based separation methods difficulties associated with complete evacuation during desorption often leads to degradation in the degree of separation. In separation by commonly used methods such as distillation the energy cost is very high. One set of methods that is of relevance here is the separation of hydrocarbon mixtures using zeolites. These are extensively used in petrochemical refineries. In other existing “active” separation processes such as those driven by an external field or gradient, the driving force acts on both the components in the same way or direction, which leads, at best, to a reasonable but not excellent separation.

The purpose of this invention is to present an alternate approach in which the two components are driven in opposite directions. By doing so, we achieve a very high degree of separation which is indicated by the high separation factors obtained in this invention. The method is based on two principles, namely, the so-called levitation effect [Reference 21] and the blow-torch effect [Reference 22]. The invention will be illustrated by passing the mixture to be separated through a column of zeolites under appropriate conditions.

Zeolites are porous solids made up of Al, Si, O and consist of interconnected network SiO₄ and AlO₄ tetrahedra. They also have small and medium sized interconnected pores of typical dimensions 1-20 Å which can accommodate molecules such as hydrocarbons. In the usual separation methods, the molecular sieving property of the zeolites is commonly used in the separation of mixtures where molecules of different sizes diffuse or pass through at different rates. The rates are determined by the self diffusivities of the different molecules. Bigger molecules typically have lower self diffusivities.

Levitation effect refers to the anomaly in self diffusivity that has been observed in porous solids [Reference 21]. Self diffusivity D exhibits a surprising dependence on the size of the guest species, σ_{gg}. This could be usually the Lennard-Jones guest-guest interaction parameter in molecular simulations. At small σ_{gg}, D is linearly proportional to 1/σ²_{gg}, as expected. This is the linear regime. At larger σ_{gg}, D shows a pronounced peak which is referred to as the anomalous or the levitating regime (see FIG. 1) [Reference 21]. This behavior is observed in all types of porous solids irrespective of the geometrical and topological details of the pore network

$$γ = \frac{{2}^{7 / 6} {σ}_{gh}}{{σ}_{w}} \qquad ( 2 )$$

[Reference 23]. A dimensionless parameter [Reference 21] called the levitation parameter may be defined. Here σ_{w} is the window diameter and σ_{gh} is the guest-host Lennard-Jones interaction parameter. The anomalous regime is seen when γ is close to unity and the linear regime for values of γ much less than 1. The maximum in self diffusivity has its origin in the fortuitous cancellation of the dispersion forces on the guest or diffusant due to the host. Such an unexpected cancellation of forces arising from the host porous medium occurs when the size of the guest is comparable to the void size (see FIG. 2). The unexpected maximum in D is due to this (see FIG. 2) when the size of the guest is comparable to the void size. Frictional forces on the guest is then lowest and this results in an increase in D. Under these conditions, it is seen that the potential energy landscape is rather flat with only smaller undulations [Reference 24]. The magnitude of the peak in D is dependent on the temperature and degree of disorder in the void network [References 25, 26]. Generally, in most guest-host systems γ is small and hence they lie in the linear regime. In order to realize the anomalous regime, a careful choice of the host system for a given guest or mixture is therefore necessary.

Zeolites possess spatial and chemical inhomogeneities. The latter is seen in the presence of chemisorption and chemically reactive sites within the zeolites. This is responsible for the catalytic properties of zeolites. Whenever reactions take place within zeolites, heat can be released or absorbed. Since zeolites are poor thermal conductors, this can lead to local hot or cold spots. The principle which deals with the effect of such hot regions on self diffusivity is the Landauer blow torch effect. The effect of inhomogenous temperature was originally treated by Landuaer [Reference 22] which now goes by the name the ‘blow torch’ effect. Briefly, he showed that introduction of a hot spot in between a lower lying minimum and barrier maximum of a bistable potential can raise the population of the higher lying minimum relative to the lower lying minimum over and above that given by the Botlzmann factor (see below). Since the blowtorch effect is rather counter intuitive, following Landauer [Reference 22], we illustrate the effect of a nonuniform temperature bath on the relative populations of competing local energy minima for a bistable potential U(x). Consider the motion of an overdamped particle in the potential U(x) shown by the curve ABCD in FIG. 3, subject to an uniform temperature T₀ along the coordinate. Then, the probability of finding a particle at x is P(x)˜exp(−U(x)/k_{B}T₀). Clearly, the probability at A is higher than that at D. Now consider raising the temperature of the region BC to T_{b}. Then P(x)˜exp(−U(x))/k_{B}T_{b} in BC is clearly much smaller than the probability P(x) at lower temperature T=T₀. Now let us consider a situation when only P(x) is given and one wishes to find the ‘effective potential’ that determines this P(x). Clearly, one can invert the original expression for P(x) and regard the ‘potential’ to be given by U(x)/k_{B}T=−lnP(x). Thus, on raising the temperature to T_{b}, the decrease in P (x) in BC, implies ln(P(x) is flatter in BC. This is equivalent to modifying the ‘potential’ to a flatter curve BC′. Since the probability P(x) is unaffected in other regions, the curve outside the region BC will be the same except that the curve CD would start at C′ and end at D′ such that U(x_{C})−U(x_{D})=U(x_{C′})−U(x_{D′}). Thus, the minimum at D is brought down relative to A. Consequently, the probability at x_{D}, P(x_{D}) is higher than that at the lower minimum x_{A}. Recently, kinetic aspects have been studied [Reference 27] for an idealized situation. More recently, a more practical realization of the blow torch effect has been demonstrated in the case of zeolite [Reference 28].

Thus, both the levitation and blow torch effects lead to enhanced diffusivity. Specifically, controlling and channelising the direction along which two or more components diffuse, can achieve significant or drastic improvement of the separation factors. A judicious combination of these two effects therefore can drive different components in opposite directions. This could be of considerable significance to the area of separation of mixtures. In the process a new conceptual basis for separation of mixtures has been introduced which helps to realize separation factors (see below) that are quantitatively superior by several orders of magnitude to the existing methods. Since both the blow torch and levitation effect can be realized in zeolites, we illustrate their combined effect on the separation of a mixture of gases confined to zeolites. The length of the separation column over which the mixture traverses is reduced significantly from macro to microscopic dimensions in the case of porous host such as zeolite. This is demonstrated using Monte Carlo simulations for (i) Lennard-Jones mixtures and (ii) Ne—Ar mixture.

### OBJECT OF THE INVENTION

It is the primary object of the invention to provide an improved method whereby a combination of levitation and blowtorch effect is used together for the separation of molecular/atomic/ionic mixtures.

It is also another object of the invention to provide an improved method for the separation of molecular/atomic/ionic mixtures, which is economical in process and efficient in operation and a substitute for traditional method of equilibrium and kinetic based methods.

Yet another object of the invention is to provide an improved method with lower energy cost and higher efficiency.

Further objects of the invention will be clear from the following description:

### IN THE ACCOMPANYING DRAWINGS

FIG. 1 shows the Levitation effect. D versus 1/σ²_{gg} plot indicating the linear and anomalous regimes.

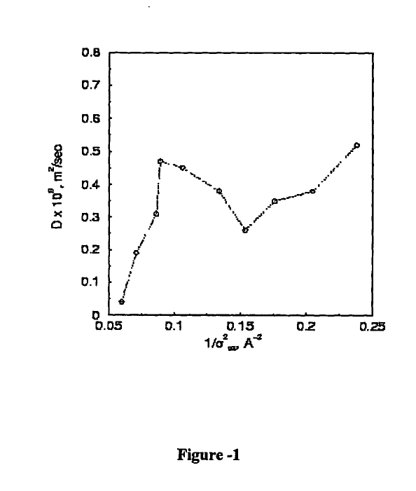

FIG. 2 shows the twelve membered ring of zeolite NaY along with two guests molecules of different sizes. The larger sized molecule experiences little or no force due to the zeolite.

FIG. 3 shows the effect of hot zone on the relative populations in the two potential energy minima. The population in the higher potential minimum at D is increased to a value higher than that seen in A in the presence of hot spot between BC of the curve.

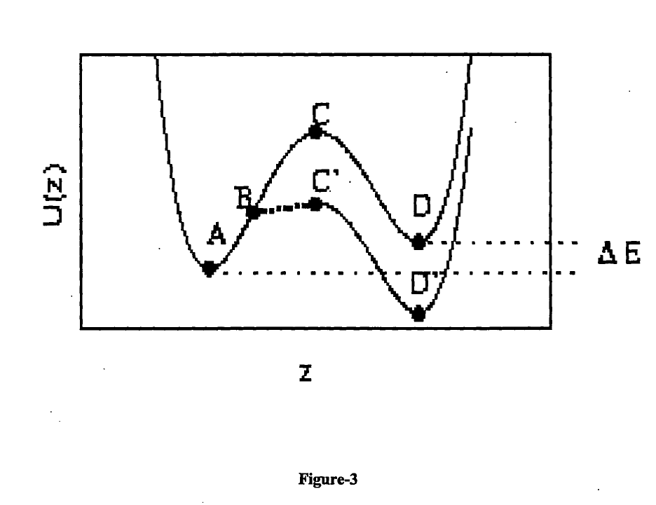

FIG. 4 shows two cages of zeolite NaCaA with the location of the physisorption sites (filled circles). Note that additional cages are present along the two directions. The potential energy variation along the z-direction for particles in the (a) linear and (b) anomalous regime are shown The location of the hot zone is indicated by dashed vertical lines.

FIG. 5 shows variation in density along z-direction of two components in mixture LR (see text) where both the components are from the linear regime. Also shown are the ratio log (n₁(z)/n₂(z))

FIG. 6 shows variation in density along z-direction for the mixture consisting of an anomalous and a linear regime component (AR, see text) and the ratio log (n₁(z)/n₂(z)). A straight line fit to log (n₁(z)/n₂(z)) has been used to obtain parameters in equation (4)

FIG. 7 shows variation in density along z-direction for Ne—Ar mixture for component Ar, Ne and the ratio log (n_{Ar}(z)/n_{Ne}(z)). A straight line fit to log (n_{Ar}(z)/n_{Ne}(z)) has been used to obtain parameters in equation (4).

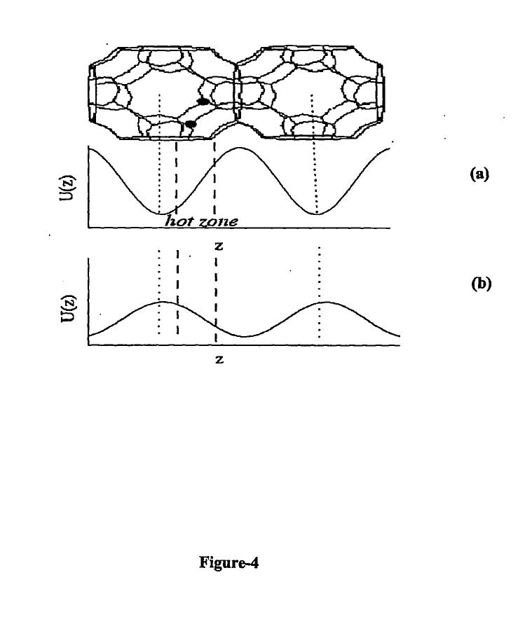

In the present invention, an attempt has been made to study the combined influence of both the blow torch and levitation effects on the separation process of mixtures within porous zeolites. The physical system that is simulated consists of a mixture of gases confined to NaCaA zeolite with a composition Na₃₂Ca₃₂Si₉₆Al₉₆O₃₈₄ (Si/Al=1.0) crystallizing into a cubic structure (space group Fm3c) with a lattice parameter a=24.55 Å [Reference 29]. Large (≈11.4 Å dia) cages (the supercages) are interconnected in an octahedral fashion to 6 other supercages via 8-ring windows of significantly narrower diameter (≈4.5 Å). The distance between two planes of 8-ring windows is given by half of the lattice parameter d_{w}=a/2=12.275 Å. Following our earlier work [Reference 28], we assume that a species arriving at a heterogeneous reaction site, typically located between the window and the cage (see FIG. 4) releases an amount of heat q creating a local hot zone. For the purpose of modeling, the reaction is mimicked by introducing a hot zone at appropriate locations. The presence of a hot zone aids the molecules to surmount a barrier more easily. Previous studies have shown [Reference 21] that the average potential energy (PE) landscape for particles in linear (γ much less than 1) and anomalous (γ≈1) regimes are substantially different. For the linear regime, the potential energy maximum and minimum are located respectively at the bottleneck (8-ring window) and the cage. For the anomalous regime, they are located at the cage and the bottleneck respectively (see FIG. 4) [Reference 21].

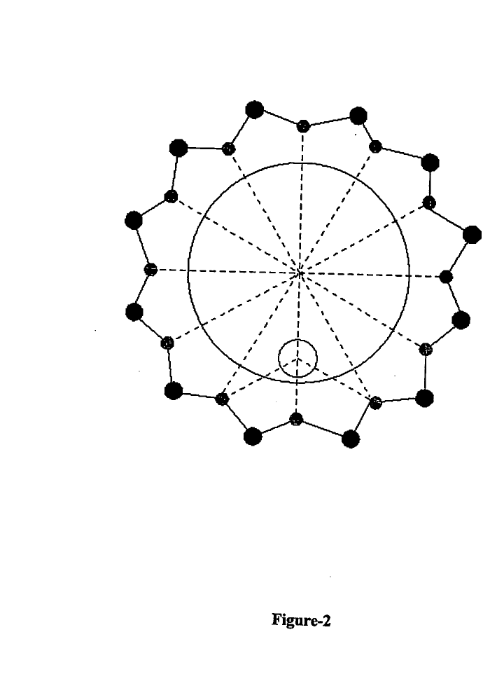

We describe the zeolite and mixture of gases interacting via the Lennard-Jones potential φ(r)=4ε[(σ/r)¹²−(σ/r)⁶]. The total interaction energy of the system consists of the guest-guest, φ_{gg}(r) and guest-zeolite φ_{gh}(r) terms:

$$φ = {\sum }_{i = 1}^{N} {\sum }_{j = 1}^{N} {ϕ}_{gg} + {\sum }_{i = 1}^{N} {\sum }_{j = 1}^{{N}_{z}} {ϕ}_{gh} \qquad ( 3 )$$

where N and Nz are the number of guest and zeolite atoms respectively. A modified Metropolis Monte Carlo algorithm in the canonical ensemble [Reference 30] has been employed. Calculations have been carried out at a temperature of T₀=140K with temperature of the hot spot, T_{b}=420K. Two sets of simulations have been carried out, the first (set A) relating to idealized particles to illustrate the basic effect, and the second (set B) on a realistic mixture of neon-argon. Both are modeled in terms of their Lennard-Jones potential parameters. A 1:1 mixture with a total of 256 particles corresponding to a concentration of C=1 per cage (of either type chosen randomly), diffusing with zeolite NaCaA has been simulated. The system consists of 2×2×8 unit cells of zeolite Y each unit cell containing 8 cages (l_{z}=8×a=196.4 Å). Periodic boundary conditions are imposed along the x- and y-directions. Along the z-direction repulsive (1/r¹²) walls are placed. For the set A itself, two simulations LR and AR defined by their respective parameters have been carried out The mixture LR consisting of particles with σ_{gg}=2.05 Å, and 2.38 Å, and mixture AR with σ_{gg}=2.38 Å and 3.34 Å. For mixture LR both the components lie in the linear regime (FIG. 2). For mixtures AR, one of the two components, viz., σ_{gg}=3.34 Å lies in the anomalous or levitating regime (FIG. 2). The Lennard-Jones interaction parameter σ_{gg}=0.997729 kJ/mol for all the guests. For the set B simulations of neon-argon mixture, the parameters are [Reference 31]: σ_{Ne—Ne}=2.72 Å ε_{Ne—Ne}=0.3908 kJ/mol, σ_{Ar—Ar}=3.41 Å ε_{Ar—Ar}=0.9977 kJ/mol. Initially a single particle of either type is placed in each cage corresponding to the equilibrium distribution in the absence of blow torch. There are two cages along each of x-, y- and z-directions per unit cell. A hot spot is placed at distances of 1.278 Å to the left of the 8-ring window planes along the z-direction (see FIG. 4). Simulations are of 6×10⁵ MC steps which includes an initial period of 5×10⁵ MC steps required for reaching a steady state. Average properties are calculated over 1×10⁵ MC steps.

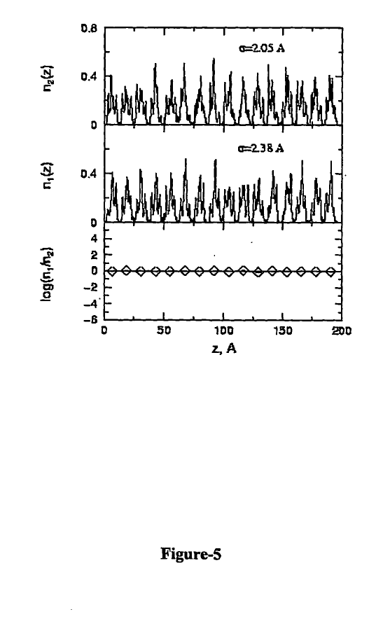

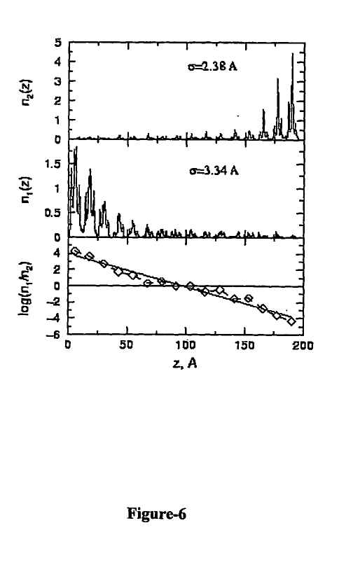

We first discuss the results of LR mixture of set A (with σ_{gg}=2.05 and 2.38 Å). FIG. 5 shows the density profile along the z-direction, nᵢ(z) for i=1,2 along with the logarithm of the ratio n₁(z)/n₂(z) along the z-direction. Clearly, there is hardly any separation of the two components. The separation factor [Reference 20] is of the order of unity. In contrast, the plots of nᵢ(z) for i=1,2 and ln(n₁(z)/n₂(z)) for the mixture AR (with σ_{gg}=2.38 and 3.34 Å) show a high degree of separation (FIG. 6). The component corresponding to σ_{gg}=2.38 Å is driven to the right and accumulates at one end while the other component with σ_{gg}=3.34 Å is driven to the left. At one extreme, the ratio n₁(z)/n₂(z) is 72.61, while at the other extreme a value of 0.01329 is obtained. This corresponds to a high separation factor [Reference 20] α=5463.

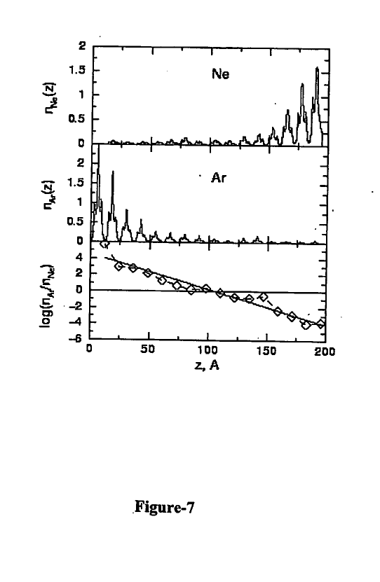

Hereinafter, the applicability of method to the separation of a mixture of real gases, namely, Ne—Ar rare gas mixture using zeolite NaCaA as the porous host is demonstrated. A plot of n_{Ar}(z), n_{Ne}(z) and their ratio ln(n_{Ar})/n_{Ne}(z)) as a function z is shown in FIG. 7. Clearly, there is an excellent separation of the two components. At the left end, the ratio n_{Ar}(z)/n_{Ne}(z) is 301.81 while at the right extreme it is 0.02255. The resulting separation factor is 1.338×10⁶. Further, use of even a few more unit cells of zeolite can enhance the separation factor by several orders of magnitude.

It is clear from FIGS. 6 and 7, that a straight line fit to the plot of ln(n₁(l)) versus l (or ln(n_{Ar}(l)/n_{Ne}(l)) versus l) provides a good approximation. Therefore, that the ratio n₁(l)/n₂(l) (or n_{Ar}(l)/
n₁/n₂=exp(−l/l_{c}+C) (4)
n_{Ne}(l)) decreases in an exponential way which can be fitted to:
where l is the length of the separation column and l_{C} and C are constants. l_{C}=22.823 Å (mixture AR) and 20.6698 Å (Ne—Ar) and C=4.2851 (mixture AR) and 5.710 (Ne—Ar mixture). Here we have fixed the magnitude of n₁/n₂(z=0) to e^{C}. From this it is easy to estimate that on doubling the length of the zeolite column from its present value l_{z}=196.4 Å, the ratio is 1.685×10⁻⁶ at the right extreme. It follows from equation 4 that the separation factor [Reference 20] for a separation column of length l_{z} may be written

$$α = \frac{{n}_{1} / {n}_{2} ( z = {l}_{z} )}{{n}_{1} / {n}_{2} ( z = 0 )} = exp ( - {l}_{z} / {l}_{c} ) \qquad ( 5 )$$

The resulting value for α on doubling the column length is 1.79×10⁸ which is more than two orders of magnitude improvement over the value 1.338×10⁶. In conventional methods of separation, the separation factor at best varies linearly with the length of the column [Reference 20]. The present method is therefore capable of providing better than parts per billion purity with columns of microscopic dimensions. The efficiency of separation is also expected to be several orders of magnitude better than obtained from conventional methods.

These results can be understood by considering the nature of the potential energy landscape for particles in the linear and anomalous regimes (FIG. 4), and the position of the hot spots. Table 1 lists the values of γ for the components of the LR, AR and Ne—Ar mixtures. In the case of LR mixture, both components fall in the linear regime as their γ values are much less than unity. For these particles, the maxima in the potential energy landscape are at the windows (zₙ=nd_{w} where n is an integer) just to the right of the hot spots (see FIG. 4a). Thus, the effect of the hot spot is to increase the escape rate over the barrier located to the right of the hot spot Stationary populations of both species in the presence of hot spots is soon established which is nearly uniform. In contrast, for the AR mixture or Ne—Ar mixture (Table 1), while one component lies in the linear regime (γ much less than unity), the other component is in the anamolous regime with γ˜1. For the latter, the potential maxima are located at the cages (zₙ=(2n+1)d_{w}/2,n an integer) which are immediately to the left of the hot spot. Thus, the hot spot has the effect of driving these particles to the left, while the other component is driven to the right. Since, the hot spots are located at periodic positions, the eventual effect is to accumulate particles of each type at the left and right extremes respectively.

Note that the present method crucially depends on the interplay of two factors, namely, the levitation and blow torch effects. It is applicable to mixtures where the two components differ in size. The realization of the levitation effect requires a careful choice of the porous host [Reference 32], which depends on a few pertinent points. Previous studies show that the enhancement of D within the anomalous regime extends over a reasonably large range of σ_{gg} [Reference 25]. This provides considerable flexibility in the choice of the host system over which the anomalous regime can be realized. There exist in nature a number of known porous solids [Reference 33] with a wide variation in pore dimensions, Further, it is also possible to vary the pore dimensions of these solids through, for instance, substitution of framework ions. Substitution of Si by Al or Si by P or Al by Ti can alter the pore dimensions [Reference 34]. Table 2 illustrates the choice of the zeolite as the host for a few realistic mixtures [Reference 33]. For the hydrocarbon mixture consisting of n-hexane, n-butane and isopentane, it is seen that isopentane alone has a γ value closer to unity and therefore the application of the present method to this mixture, isopentane alone would be driven to the left while the other two would be driven to the right. Thus it is possible to separate out isopentane from other components. The other binary mixture of CCl₄ and CF₄ the component with γ value closer to unity would be driven to left and the other component with γ much less than 1 will be driven to the right.

It is also practically possible to realize the hot spots necessary to drive the different components of the mixture. We consider hydrocarbons and other guest species sorbed within zeolite NaX. Table 3 lists isosteric heat of sorption (ΔH_{ads}) of some linear alkanes, Xe and water within faujasites [Reference 33]. We have also listed the mean heat capacities (Cₘ) of guest-zeolite systems [Reference 33]. From these data, the maximum increase in ΔT can be estimated from ΔT=T_{b}−T₀=ΔH_{ads}/Cₘ which is in the range 820 K to 1300 K Changes in temperature of this magnitude can be achieved if for example, a specific chemical group can be attached to the oxygen of the zeolite framework at the appropriate place at the place where the hot spot is desired. The chemical group can then be vibrationally excited by exposing it to appropriate radiation. Thermal de-excitation of the excited group would provide constant heat source. The system would soon reach a steady state nonequilibrium state with a temperature gradient. The location of the chemical group has to be asymmetric with respect to the barrier, i.e. placed only on one side of the barrier.

The utility of the invention for separation of mixtures in the context of zeolites [Reference 35] has been successfully demonstrated. At a fundamental level, this method of separation is different from conventional methods: the combined result of the two effects is to force the components of the mixture in opposite directions leading to high degree of separation In contrast traditional methods of separation drive both the components in the same direction but at different rates. For example, in distillation, the vapour pressure of both components increases on heating. Or, and increase in concentration gradient may lead to higher self-diffusivities of both the species. Consequently, the separation factor is limited by the differential rate of the various components. More importantly at the practical level, the present method achieves separation at microscopic length scales as compared to macroscopic length scales in conventional methods since the basic effects giving raise to the separation operate at nano length scales.

The energy cost associated with the present method is expected to be significantly lower than in the traditional methods. The hot spot required in the present method will add to the energy cost However the nano lengths at which separation is achieved implies that the number of hot spots to be maintained are only few. Most of the energy cost in conventional methods of separation is due higher temperatures that need to be maintained over long columns. In contrast, the energy saved in the present method is large (=CₚΔT per mole).

As an illustration of the effectiveness of the above method, consider the conventional method of separation of hydrocarbon using zeolites [Reference 20]. Here, the separation factor is controlled by geometrical features such as size and shape of the molecules. However, if one were to follow our method, one should attempt to make an appropriate choice of the zeolite for use of the levitation effect along with suitably engineer hot spots that can be used to obtain orders of magnitude improvement in separation of hydrocarbons.

While the present exercise illustrates the combined use of blow torch and levitation effect in the context of separation of mixtures, the concept is clearly more general and should find application in several situations, including biological processes. The present study suggests a possible mechanism by which ions diffusing across bio-membranes can do so with minimum activation energy. Further the levitation effect suggests that if the channel dimension through which the ions diffuse is about the size of the ion, then the activation energy for diffusion is lowest [Reference 25]. Finally, the present investigation provides possibilities for the design of drug delivery systems, where an encapsulated drug may be released at the affected part through the release of heat, which can be achieved through externally, provided radiation. Heat released will enhance the diffusivity leading to dispersal of the drug.

TABLE 1
The value of γ defined in Eq. 2 for different guests in zeolites A.

| σ_{gg,} Å | γ |
|---|---|
| 2.05 | 0.73 |
| 2.38 | 0.79 |
| 3.34 | 0.94 |
| 2.72 (Ne) | 0.84 |
| 3.405 (Ar) | 0.95 |

Table 2 choice of zeolite for hydrocarbon and other mixtures chosen so that one of the components has a value of γ close to unity.

| System | 2^{7/6} σ_{gh,} | γ | zeolite |
|---|---|---|---|
| Isopentane | 10.03 | 0.995 | faujasite^{a} |
| n-hexane | 8.08 | 0.799 | |
| n-butane | 8.08 | 0.799 | |
| CCI₄ | 8.39 | 0.829 | faujasite |
| CF₄ | 6.99 | 0.692 | |

^{a}σ_{w} = 10.11 Å

TABLE 3
Expected rise in temperature for typical guests when adsorbed
in common zeolites estimated from heat of adsorption ΔH_{ads}
and the mean heat capacity Cₘ data.

| System | | ΔHᵥₐₚ | ΔH^{a}_{ads} | Cₘ | T_{b}-T₀ |
|---|---|---|---|---|---|
| Guest | Zeolite | kJ/mol | kJ/mol | J/mol. K | K |
| n-C₄H₁₀ | Na-X | 66 | 174 | 105 | 1689^{b} |
| n-C₇H₁₆ | Na-X | 87 | 228 | 176 | 1809^{b} |
| n-C₇H₁₆ | Na-X | 87 | 228 | 209 | 1090^{c} |
| neo-C₅H₁₂ | Na-X | 54 | 130 | 129 | 1011^{b} |
| iso-C₈H₁₈ | Na-X | 88 | 246 | 185 | 1329^{d} |
| Xe | Na-Y | . . . | 18 | 22 | 820^{e} |
| H₂O | Na-X | . . . | 142 | 70 | 2028^{b} |

^{a}Calculated from ΔHᵥₐₚ and the ratio of ΔH_{ads}[34].
^{b}T₀ = 300 K;
^{c}T₀ = 333 K;
^{d}T₀ = 325 K;
^{e}T₀ = 473 K.

### REFERENCES

[1] L. S. Cheng and S. T. Wilson, U.S. Pat. No. 6,293,999.
[2] M. Tanaka and S. Sugiyama, U.S. Pat. No. 5,851,381.
[3] T. Tsutsui, T. Sasaki, Y. Satou, O. Kubota, S. Okada and M. Fujii, U.S. Pat. No. 6,204,422.
[4] H. Hachisuka, K. Ikeda and K. Inoue, U.S. Pat. No. 5,709,733.
[5] D. A. LaMonica, U.S. Pat. No. 5,545,329.
[6] J. Yao, J. J. Chen, R-J. Lee and D. G. Elliot, U.S. Pat. No. 6,116,050.
[7] E. Barbera-Guillem and M. O. Thurston, U.S. Pat. No. 6,126,835.
[8] F. Fuentes, P-O. Delle, A. Willemot, L. Barry, F. Fillet and J-L. Gelot, U.S. Pat. No. 5,538,536.
[9] K. F. Butwell, W. B. Dolan and S. M. Kuznicki, U.S. Pat. No. 6,315,817.
[10] R. D. Rothchild, U.S. Pat. No. 5,672,197.
[11] M. J. Mitariten, U.S. Pat. No. 5,245,099.
[12] W. G. O'Brian, C. J. Noelke, R. C. Harker, D. J. van Bramer, U.S. Pat. No. 6,123,749.
[13] W. G. O'Brian and B. A. Mahler, U.S. Pat. No. 5,858,066.
[14] K. H. Lee, U.S. Pat. No. 5,456,841.
[15] R W. Baker, K. A. Lokhandwala, D. Gottschlich and M. L. Jacobs, U.S. Pat. No. 5,755,855.
[16] A. Shimazu, T. Matshusita, T. Miyazaki and K. Ikeda, U.S. Pat. No. 6,252,038.
[17] G. Paret and R. Paludeto, U.S. Pat. No. 5,510,562.
[18] P. Boucot, J-A. Chodorge, A. Forestiere, Y. Glaize and F. Hughes, U.S. Pat. No. 5,853,551.
[19] I. Sucholeiki, U.S. Pat. No. 6,277,332.
[20] J. D. Seader and E. J. Henley, Separation Process Principles, (John Wiley, New York, 1998).
[21] S. Yashonath and P. Santikary, J Phys. Chem., 98, 6368 (1994).
[22] R. Landauer, Phys. Rev. A. 12, 636-638(1975).
[23] S. Bandyopadhyay and S. Yashonath, J. Phys. Chem., 99, 4286 (1995).
[24] R. Chitra and S. Yashonath, J. Chem. Phys., 110, 5960 (1999).
[25] R Chitra and S. Yashonath, Faraday Discuss., 106, 105 (1997).
[26] A. V. Anil Kumar and S. Yashonath, J. Phys. Chem., B 104, 9126 (2000).
[27] M. Bekele, S. Rajesh, G. Ananthakrishna, N. Kumar, Phys, Rev. E. B59, 143-149 (1999).
[28] A. V. Anil Kumar, S. Yashonath and G. Ananthakrishna, Phys. Rev. Lett, 88, 20601 (2002).
[29] J. J. Pluth and J. V. Smith, J. Am. Chem. Soc., 102, 4704 (1980).
[30] N. Metropolis, A. W. Rosenbluth, M. N. Rosenbluth, A. H. Teller and E. Teller, A J. Chem. Phys., 21, 1087 1953).
[31] M. P. Allen and D. J. Tildesley, Computer Simulation of Liquids, (Clarendon Press, Oxford, 1987).
[32] R. Chitra and S. Yashonath, Mol. Phys., 98, 657 (2000).
[33] R. M. Barrer, Zeolites and Clay Minerals as Sorbents and Molecular Sieves (Academic Press, London, 1978).
[34] V. Thangadurai, A. K. Shukla and J. Gopalalkrishnan, J. Mater. Chem., 9, 739 (1999).
[35] G. Ananthakrishna, A. V. Anil Kumar, and S. Yashonath, Indian Patent Application no. 1006/MAS/2001 dated 18-12-2001.

1. An improved method for separation of molecular/atomic/ionic mixtures by simultaneously subjecting the mixture to be separated to a combined influence of “levitation” and “blow torch” effects.

2. An improved method as claimed in claim 1, wherein the host material is selected so that at least one of the components to be separated from the rest of the components present in the mixture lies in the anomalous regime.

3. An improved method as claimed in claim 1, wherein the host material is selected so that at least one of the components to be separated from the rest of the components present in the mixture lies in the linear regime.

4. An improved method as claimed in claim 1-3, wherein the number of blow torches/hot spots to be provided depend on the physical properties of the molecular/atomic mixture to be separated together with the properties of the host.

5. An improved method as claimed in any one of claims 1 to 4, wherein the blow torches/hot spots are provided in between the maxima and minima of the potential energy landscape of the host-guest system chosen.

6. An improved method as claimed in any one of the preceding claims, wherein the component with γ value closer unity is driven to one extreme and the other component with γ much less than unity is driven to the opposite extreme of the separation column.

7. An improved method as claimed in any one of the preceding claims, wherein a specific chemical group is attached to the host at the appropriate place where the hot spot is desired.

8. An improved method as claimed in claim 7, wherein the location of the chemical group is asymmetric with respect to the barrier, i.e. it is placed only on one side of the barrier.

9. An improved method as claimed in any one of the preceding claims, wherein the term host refers to any system wherein both blow torch and levitation effect are realized and not just zeolites.

10. An improved method as claimed in any one of claims 1 to 9, wherein the mixture to be separated is selected from a mixture of hydrocarbons, biological and ionic solutions, mixture of gaseous substances, mixture of proteins and the like.

11. An improved method as claimed in any one of claims 1 to 10, wherein additional additives are introduced to realize the blow torch effect.

12. An improved method as claimed in any one of the preceding claims, wherein the separation is carried out on nano to micrometer length scales.

13. An improved method as claimed in any one of the preceding claims, wherein the separation is carried out in single or multiple stages.
